(19) United States
(12) Patent Application Publication
(10) Pub. No.: US 2023/0280036 A1
(43) Pub. Date: Sep. 7, 2023

(54) OVEN SYSTEM

(71) Applicant: Gozney Group Limited, Christchurch Dorset (GB)

(72) Inventor: Thomas Robert Llewelyn GOZNEY, Dorset (GB)

(21) Appl. No.: 17/800,702

(22) PCT Filed: Feb. 15, 2021
(86) PCT No.: PCT/EP2021/053641

§ 371 Date: Aug. 18, 2022

(30) Foreign Application Priority Data
Feb. 19, 2020 (GB) 2002313.1

(51) Int. Cl. F24C 1/06; A23B 4/052; A47J 37/06

(52) U.S. Cl. CPC F24C 1/06; A23B 4/052; A47J 37/0658; A47J 37/0647; A47J 37/0664

(57) ABSTRACT

Disclosed is an oven comprising an oven chamber, a base and an aperture. The oven chamber is for containing foodstuffs during a cooking or curing process. The base is for supporting the oven chamber and comprises a cavity for receiving an accessory for supplying energy to cook or cure foodstuffs. The aperture is for permitting energy from the accessory to flow into the oven chamber.

### CROSS-REFERENCE TO RELATED APPLICATIONS

The present application is a U.S. National Stage filing under 35 U.S.C. 371(c) of International Application No. PCT/EP2021/053641, filed Feb. 15, 2021, which claims priority to Great Britain Patent Application No. 2002313.1, filed Feb. 19, 2020, the disclosures of which are hereby incorporated by reference in their entireties.

The present disclosure relates to an oven system for cooking or curing foodstuffs. For example, some aspects of the present disclosure may relate to an oven for cooking a pizza (e.g. a pizza oven).

### BACKGROUND

Ovens for cooking or curing foodstuffs are known. Most ovens are dedicated to being operated with a single energy source, such as a gas burner, and electric heating element, or a solid-fuel fire only.

In some ovens, the addition of an accessory such as a heat source or a smoker takes up cooking space within the oven chamber, meaning that a user cannot fit as much food in the oven. For example, a foodstuff may be smoked by placing a source of smoke in the oven next to the foodstuff, which will take up space that could otherwise be occupied by additional foodstuffs. Furthermore, the accessory can affect the airflow in the oven (e.g. can affect the regulation of the airflow) and removal of the accessory may necessarily interrupt and/or interfere with the cooking or curing process in the oven. If the accessory comprises hot ash then this may, in turn, make removal of the accessory difficult without spilling potentially dangerous contents.

Further developments in the field of ovens would be desirable.

### STATEMENTS OF INVENTION

According to a first aspect of the present disclosure, there is provided an oven comprising an oven chamber for containing a foodstuff during cooking or curing, a base for supporting the oven chamber, the base comprising a cavity for receiving an accessory for supplying energy to cook or cure a foodstuff (for example a foodstuff contained in the oven chamber) and an aperture for permitting energy from the accessory to flow into the oven chamber.

The oven cavity is therefore an accessory port for the oven. An accessory, and in particular, an energy source accessory (such as a cold smoker, hot smoker, or heat source as described above) may therefore be received in the cavity to supply energy to the oven chamber. In this way, access to the oven is not limited or restricted, since the accessory port is provided in the base, and the oven chamber space can be fully utilized. Furthermore, as access to the cavity is below the oven chamber, space is not only maximized but the accessory port may be accessed in a safe way that does not disturb a cooking or curing process, or the oven chamber itself. In this way, a cooking or curing process in the oven chamber is effectively separated from introducing, or altering, an accessory providing heat or smoke to the oven chamber. Providing the cavity in the base also means that more control over the airflow may be maintained. It may also mean that the oven may maintain optimum dimensions even when an accessory is used as the accessory may be received in the base. In other words, the oven may be kept as compact as possible.

Accessories may therefore be slid out of the cavity in the base, which may also be referred to as a side hatch given its location in the base relative to the oven. The accessory that is received in the cavity may comprise at least one of (but is certainly not limited to) an energy source, such as a solid or liquid fuel burner, cold smoker, pellet burner, air regulator, smoke injector or ash tray. As the cavity is provided in the side of the oven, removal of the accessory is convenient and does not require any specialist equipment or tools.

According to this aspect, an oven chamber is supported by an oven base and the oven base comprises a cavity for receipt of an energy source that it configured to supply energy to cook or cure a foodstuff in the oven chamber. For example, a foodstuff may be received in the oven chamber for a cooking process in which the energy source is configured to supply heat energy (and/or smoke) to cook the foodstuff, or for a curing process in which the energy source is configured to supply energy to smoke the foodstuff (e.g. cold smoke—sometimes known as “cold smoking”). Therefore, the oven according to this aspect is configured to receive a foodstuff for a cooking process, a hot smoking process, a cold smoking process, a steaming process, or any other process in which the foodstuff may be subject to energy to treat the foodstuff

The aperture permits fluid communication between the cavity and the oven chamber. That is, the aperture is configured to permit energy in the cavity to flow into the oven chamber. Therefore, when an accessory is received in the cavity the aperture is configured to permit energy to flow from the accessory into the oven chamber. The cavity may comprise the aperture. Alternatively, another part of the oven may comprise the aperture. The aperture is therefore configured to conduct heat or smoke from the cavity (from an accessory received therein) through to the oven chamber.

The cavity may be located underneath (for example, directly underneath) the oven chamber and/or the oven floor. At least a portion of the cavity may be located underneath (for example, directly underneath) the oven chamber and/or oven floor, e.g. substantially all or all of the cavity may be located underneath (e.g. directly underneath) the oven chamber and/or oven floor. In these examples the cavity may be positioned so that the passage of energy from an energy source contained in the cavity (e.g. the accessory) has a minimum distance to travel to reach the oven chamber. The distance between the cavity and the oven chamber may be further minimized in examples when the cavity comprises the aperture. In these examples the cavity may be directly connected to the oven chamber via the aperture. In other words, the aperture provides access between the cavity and the oven chamber. Although, in other examples to be described below, the cavity may be connected to the oven chamber via a conduit.

The cavity may comprise an opening in the side of the base. The “side” of the base should be understood to be a lateral side, so it may include the side, front, or rear. The base may provide a support or foundation for the oven chamber such that the oven chamber may be placed on a surface by placing the base of the oven on the surface. The oven chamber may be atop the base, or above the base. The base may therefore be below the oven chamber. The base may comprise a sidewall and the sidewall may comprise an opening to permit access to the cavity. For example, the sidewall may comprise a door, flap or similar to selectively permit access to the cavity. The opening of the cavity may comprise an interface between the cavity and the base. The cavity may comprise an inner portion of the base. Put another way, the base may comprise at least a portion of the cavity, for example all, or substantially all, of the cavity. The opening of the cavity may define an interface between an interior portion of the base and an exterior surface of the base. Entrance into the cavity may therefore be via the opening.

The oven chamber may be at least partially surrounded by an oven housing, for example fully surrounded by an oven housing. The housing may partially surround the oven chamber such that the housing defines an opening, the opening defining an entrance into the oven chamber and therefore an inlet for foodstuffs to be cooked or cured inside the oven chamber. The housing may comprise a door to permit selective (rather than continuous) access to the oven chamber.

The accessory, which the cavity is configured to receive, may comprise a smoke source and/or a heat source. The smoke source may comprise a hot or cold smoke source. In other words, the accessory may be an energy source configured to “hot smoke” or “cold smoke” a foodstuff, for example a foodstuff contained in the oven chamber. The accessory may therefore comprise a curing element. For example, the smoke source may comprise wood chips to produce smoke for smoking the foodstuff. The heat source may comprise a gas-fuel cooking source and/or a non-gas-fuel cooking source. The heat source may be configured to cook a foodstuff, for example configured to steam or roast a foodstuff (e.g. a foodstuff in the oven chamber). In one example, the accessory may comprise a source of fire, a source of smoke, or a source of steam. In these examples, the aperture is to direct the heat, smoke, or steam into the oven chamber to cook, smoke, or steam a foodstuff in the oven chamber.

The oven may comprise a blanking cap for selectively covering the aperture. The blanking cap may be configured to at least partially cover the aperture. In these examples, the amount of heat (or smoke or steam etc.) able to migrate from the cavity (more specifically, an accessory received in the cavity) into the oven chamber may be controlled. For example, the accessory may comprise burning or smoldering wood, or coal, or ash, which may be received in the cavity. In an initial phase which may correspond to roasting a joint of meat (received in the oven cavity) at a relatively high temperature the blanking cap may be such that the aperture is fully open (in other words, the blanking cap may not cover the aperture at all). However, following this initial phase of roasting at high heat the blanking cap may be moved to cover at least a portion of the aperture, thereby limiting the amount of heat able to migrate into the oven chamber, which will thereby reduce and/or control the heat in the oven chamber to reduce and/or control the cooking of the meat.

It will therefore be appreciated that the accessory may be an accessory comprising a separate energy source (e.g. a heater) but may itself be the heat source. For example, the accessory may comprise coal, wood, metal, water etc.

The oven may comprise an oven floor. The oven floor may form a surface of the oven chamber. The oven chamber may therefore comprise the oven floor. The oven floor may define a cooking surface of the oven. The oven floor may define an upper surface of the base. In these examples, the oven floor may comprise the aperture. In this example, the cavity may be located such that an opening (the aperture) in the oven floor is configured to conduct heat from the cavity (from an accessory received therein) through to the oven chamber. The aperture may be a first aperture and the oven may comprise a second aperture. In these examples, one of the apertures may be provided in the cavity and the other aperture may be provided in the oven floor. One of the two apertures may be provided in the base. In these examples, the two apertures may be connected via a conduit. The conduit may be suitable for conducting heat and/or smoke and/or steam etc. from the cavity through to the oven chamber. The conduit may comprise two ends and each end of the conduit may comprise one of the two respective apertures. The conduit therefore fluidly connects the cavity to the oven chamber and forms a passage for energy to be supplied to the oven chamber from the cavity (when an accessory is received in the cavity).

The cavity may be located underneath (for example, directly underneath), or below, the oven floor. For example, all or part of the cavity may be located underneath (for example, directly underneath), or below, the oven floor.

Therefore, as explained above, in some examples the cavity may be directly connected to the oven chamber via the aperture. In these examples the cavity may be located directly underneath the oven chamber and the aperture may act as a window between the cavity and the oven chamber. However, in other examples, the cavity may be fluidly connected to the oven chamber via a conduit—for example a conduit between a first aperture in the cavity and a second aperture in the oven chamber. In these examples the second aperture may be located in the oven floor (e.g. the oven floor may comprise the aperture) in which case the conduit may be to route energy away from the cavity and to a part of the oven chamber remote from the cavity, or another part of the oven chamber may comprise the aperture. For example, the conduit may route energy to an aperture in a ceiling, or a surface (e.g. a side surface or a top surface) of the oven chamber so that the energy is directed to different areas of the oven chamber.

The cavity may comprise a slidable drawer. The slidable drawer may be for receiving the accessory. For example, the slidable drawer may be for receipt of burning or smoldering wood, e.g. logs or wood chips or pellets or coal etc. However the slidable drawer may also be for receiving waste as a result of the accessory generating energy—for example the slidable drawer may comprise an ash tray or similar for receipt of ash following the burning of a heat source. The slidable drawer may therefore aid in insertion and removal of the accessory into and out from the cavity and therefore into and out from the oven.

The oven may comprise the accessory. The accessory may be slidably received in the cavity of the oven and removable from the cavity of the oven. The accessory may be laterally insertable and/or removable, for example slidably received in the cavity in the lateral direction. As the base comprises the cavity, in these examples the accessory may be slidably received in the base in a lateral direction. The term “lateral direction” should be understood as meaning perpendicular to a vertical direction. For example, a “lateral direction” may be synonymous with being movable “from the side” (e.g. in a sideways direction relative to how the oven is in use), or “from the front” (e.g. in a rearwards direction relative to how the oven is in use), or “from the back” (e.g. in a forwards direction relative to how the oven is in use).

For example, if the base is supported on a surface and the oven chamber is supported by the base (e.g. is atop the base) the lateral direction may be defined as the sideways, forwards, or backwards direction relative to oven. Therefore, in these examples, the accessory may be insertable (e.g. slidably receivable) in the side of the oven (e.g. in the side of the base), the front of the oven (e.g. in the front of the base), or the back/rear of the oven (e.g. the back/rear of the base). In these examples the cavity may comprise an opening in the side of the base. By providing a cavity in which the accessory is received in a lateral direction, as opposed to a vertical direction, the vertical space underneath the oven (i.e. the base) may be minimized. This may provide a more compact oven.

The oven may be configured to permit energy from the accessory to flow into the oven chamber substantially vertically from the base of the aperture. For example, the oven may be configured to allow energy from the cavity (e.g. emanating from an accessory contained therein) to flow upwards (e.g. in a vertical direction) and into the oven chamber.

According to a second aspect of the present disclosure, there is provided an oven system kit or kit of parts comprising the oven as described above and one, or more, accessories each accessory of the one or more accessories being for supplying energy to cook or cure a foodstuff. The first accessory is for supplying energy of a first type to cook or cure foodstuffs and the second accessory for supplying energy of a second type different to the first type to cook or cure foodstuffs. The first and second accessories are each configured to be slidably receivable in and removable from the cavity of the oven so as to provide different types of energy to the oven chamber.

The accessories may be complementarily shaped to the cavity, so as to substantially seal the cavity or the exterior opening of the cavity. Each accessory may have a substantially identical outer shape which corresponds to the shape of the cavity. Each accessory may substantially fill the cavity. Thus, the accessories may maximize the space utilization in the cavity and/or may minimize heat or energy losses from the opening of the cavity and ensure heat or energy from the accessory is predominantly directed into the oven chamber via the aperture, rather than lost to the ambient environment.

In some examples, the oven system kit may comprise three or more accessories, each for supplying an alternative energy for cooking or curing foodstuffs. Non-limiting examples of accessories include:
cold smoker;
hot smoker;
heat source;
a burner with adjustable airflow or air inlet;
electric heating element;
gas burner;
hot air blower; and/or
steam generator.

In another aspect of the disclosure there is provided an oven as described above comprising at least one cavity (e.g. a plurality of cavities, e.g. at least two cavities), each one of the at least one cavities being described above. Therefore, each one of the at least one cavities being to receive an accessory. In this way, different energy sources may be received in the base of the oven and the oven is thereby configured to treat a foodstuff contained in the oven chamber with different types of energy. For example, a first cavity may receive wood chips to generate smoke to smoke a foodstuff in the oven chamber and a second cavity may receive burning or smoldering coals to provide heat energy to the foodstuff

Therefore, according to various aspects of this disclosure there is provided an oven providing access through the base of the oven (sometimes referred to as the floor or deck of the oven) through which various accessories may be attached, such as a cold smoker. The accessory may be attached by being inserted into the cavity (or a port) on the side of the oven. This increases the usable space within the oven and allows the user to access the cavity, to thereby access the accessory, independently of a foodstuff that is cooking or curing in the oven chamber. Therefore, the user may access the accessory without disrupting a foodstuff in the oven chamber. Having the cavity accessibly from outside of the oven also allows the user to switch, or add, accessories without having to modify or move the main oven chamber.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a perspective view of an oven; and

FIG. 2 is a sectional view of the oven of FIG. 1.

### DETAILED DESCRIPTION

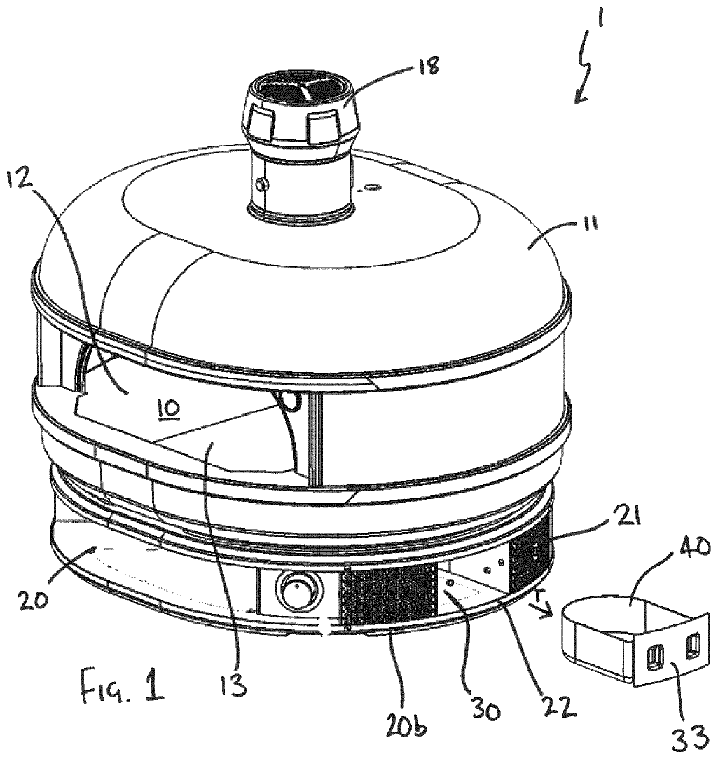

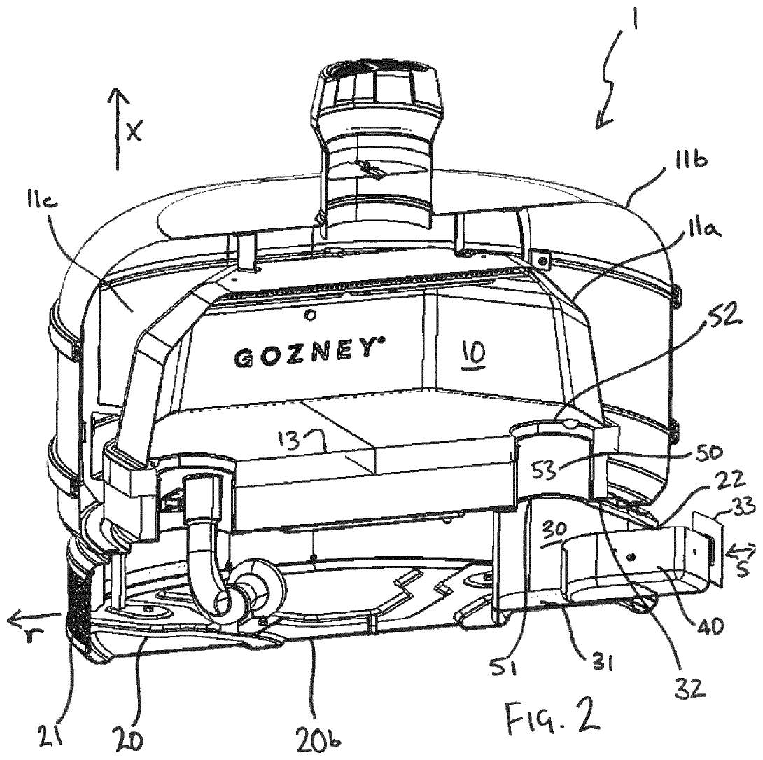

FIGS. 1 and 2 show an oven 1 comprising an oven chamber 10 for containing a foodstuff (not shown in FIG. 1) during cooking or curing. The oven 1 comprises a base 20 for supporting the oven chamber 10. The base 20 comprises a bottom surface 20b that is intended to contact the ground, or a support surface, in use to support the oven chamber 10. The oven chamber 10 sits atop the base 20. The base 20 is therefore a structural support for the oven chamber 10. In other examples, the base may comprise legs for supporting the base and/or oven chamber.

The base 20 comprises a cavity 30 for receipt of an accessory (not shown), the accessory being for supplying energy to cook or cure a foodstuff (for example heat, smoke, or steam etc.). The oven 1 comprises an aperture, or an opening, 50, shown in FIG. 2, for connecting (e.g. fluidly connecting) the cavity 30 and the oven chamber 10. The aperture 50 is for permitting energy in the cavity 30 to flow into the oven chamber 10. The aperture 50 is therefore for permitting energy from the accessory (when the accessory is at least partially received in the cavity 30) to flow into the oven chamber 10.

The oven 1 comprises an oven housing 11 that at least partially surrounds the oven chamber 10. The oven housing 11 at least partially encloses the oven chamber 10. As shown in FIG. 1, the housing 11 does not fully enclose the oven chamber 10 in that the housing 11 comprises an opening 12. The opening 12 in the oven housing 11 provides access to the oven chamber 10, for example for the transportation of a foodstuff to place the foodstuff in the oven chamber 10 for cooking or curing the foodstuff. The opening 12 may be referred to as an oven mouth.

The oven 1 comprises an oven surface 13, for example a cooking surface, for example an oven floor. It will be appreciated that the cooking surface 13 of the oven 1 may become hot during use and may heat and/or cook a foodstuff contained in the oven chamber 10. For example, the oven floor 13 may heat up and radiate heat into the oven chamber 10. For example, when a foodstuff is placed in the oven chamber 10 on a rack, elevated from the floor 13, the floor 13 may radiate heat around the foodstuff to cook the foodstuff. Alternatively, if a foodstuff is placed directly on the oven floor 13 then the heat from the oven floor 13 may cook (for example, crisp) the bottom of the foodstuff (e.g. the part of the foodstuff in contact with the hot oven floor 13). This latter example may be when the oven 1 is used as a pizza oven and a pizza is placed in the oven chamber 10, on the oven floor 13, to cook. In these examples the hot oven floor 13 may cause the base of the pizza to crisp.

It will be appreciated from the figures that the cavity 30 is located in the base 20 directly below or underneath at least part of the oven chamber 10 and directly below or underneath the oven floor 13. Locating the cavity 30 directly below the oven chamber 10 and oven floor 13 takes advantage of the natural tendency for energy in the cavity (e.g. heat or smoke) to migrate upwards, thereby reducing energy dissipation before the energy reaches the oven chamber.

As shown in FIG. 2 the aperture 50 may comprise an aperture 51 in the cavity 30 and/or an aperture 52 in the base and/or part of a conduit 53 that connects the cavity 30 to the oven chamber 10. In other words, in the example of FIGS. 1 and 2, the cavity 30 comprises a first aperture 51 and the oven floor comprises a second aperture 52. A conduit 53 connects the two apertures 51, 52, such that the two apertures 51, 52 are the openings at either end of the conduit 53. In this example, the cavity 30 comprises an aperture that is the opening to the conduit 53 and thereby allows energy in the cavity 30 (e.g. emanating from the accessory) to enter the conduit 53. The conduit 53 is configured to direct the energy into the oven chamber 10. In the example of FIG. 2, the conduit 53 is to direct the energy upwards and into the oven chamber 10 through the oven floor 13 (e.g. via or through the aperture 52 in the oven floor 13). In this way, the arrangement of the first and second apertures 51, 52 and the conduit 53 may direct the energy upwards and into the oven chamber 10 through the oven floor 13. The combination of 51, 52 and 53 may also be considered to be a single aperture of the oven 1. It should be understood that the conduit 53 extends through any insulation provided under the oven floor 13. Therefore, the conduit provides communication between the cavity 30 and the oven chamber 10 through the oven floor 13 and any insulation beneath the oven floor.

The cavity 30 comprises a lower surface 31, an upper surface 32 and at least one sidewall 33. The upper surface 32 of the cavity comprises the aperture 51 but, in other examples the aperture 51 may be provided in the side surface 31 or lower surface 33 depending on the example.

Other arrangements of the cavity, aperture and conduit however may be utilized and are within the scope of this disclosure. For example, the cavity 30 may be positioned closer to the oven chamber 10 to shorten the length of the conduit 53. In other examples the conduit 53 may extend in a different direction. For example, the oven in use defines an upwards, or vertical direction, direction X and in the example of FIG. 2 the conduit 53 has an axis parallel to the axis X such that the conduit 53 is configured to direct fluid in an upward, or vertical, direction. However, the oven housing 11 may comprise the second aperture 52 in a side wall of the oven housing (rather than the ape true 52 being provided in the oven floor 13), or a in a ceiling of the oven housing 11. In these examples, the conduit 53 may extend in a lateral direction (the lateral direction being perpendicular to the upward direction X). In these examples also, the first aperture 51 may be provided elsewhere in the cavity 30. For example, a sidewall 33 of the cavity may comprise the aperture 51 and the conduit 53 may direct fluid from the aperture 51 in the sidewall 33 of the cavity 30 to the aperture 52.

As shown in FIG. 2, the oven housing 11 may comprise an outer oven housing 11b and an inner oven housing 11a. The inner oven housing 11a may be an oven chamber housing 11a. In other words, the inner housing 11a may at least partially surround, or enclose, the oven chamber 10. In examples where the aperture 52 is not located in the oven floor 13 the inner housing 11a may comprise the aperture 52. The inner and outer oven housings 11a, 11b may define a region 11c therebetween. In some examples the conduit 53 may be located in the region 11c between the inner and outer oven housings 11a, 11b. The conduit 53 may therefore be located in between the oven chamber 10 and an outer surface 11b of the oven 1.

The base 20 comprises at least one sidewall 21. In the examples depicted in FIGS. 1 and 2 the base 20 comprises a cylindrical base and the sidewall 21 comprises a cylindrical sidewall. This defines a radial direction r, perpendicular to the upward or axial direction X. The radial direction r may also be referred to as the lateral direction. Of course, in other examples the base 20 may comprise a shape other than cylindrical (for example, rectangular). In any case, the sidewall 21 comprises an opening 22. The opening 22 is to permit access to the cavity 30. The cavity 30 may comprise the opening 22 which may therefore effectively comprise an entrance to the cavity 30. The cavity 30 may therefore be configured to receive an accessory in the lateral, or radial, direction r. In other words, in the examples of FIGS. 1 and 2, the cavity 30 is configured to slidably receive the accessory, e.g. in the lateral direction. The cavity 30 therefore comprises a lateral opening in the base 20. In this way a user may conveniently slide an accessory into the side of the 20 to provide a heat source for the oven 1. The accessory is also slidably removable from the cavity 30, e.g. in the lateral direction. In this way a user may conveniently remove the accessory from the base either to terminate the cooking or curing process or to replace the energy source for continued cooking or curing.

In the example of FIGS. 1 and 2, a slidable drawer 40, in particular a burner drawer, is provided for optional use. Drawer 40 is an exemplary accessory for providing energy for cooking or curing foodstuffs. In this example, the sidewall of the cavity 33 is formed integrally with the drawer 40 such that, when the drawer 40 is received in the cavity 30, the sidewall 33 forms a substantially continuous portion of the sidewall 21 of the base 20. In this example, if a solid fuel source, such as wood, is to be burned to supply energy to the oven chamber 10, the drawer 40 can be removed from the cavity 30 in the radial direction r, as shown in FIG. 1, the solid fuel can be placed in the drawer 40, ignited, and the drawer 40 slidably inserted back into the cavity 30.

As shown in FIG. 2, the drawer 40 can be slidably inserted and removed as required, as indicated by the arrow S. If another type of energy source accessory is to be utilized, such as a smoker or steamer, then the burner drawer 40 can be removed and set aside, and the accessory can be slidably inserted into the cavity 30 instead of the drawer 40. Therefore, the oven can be conveniently set-up as required by the user for the particular cooking or curing operation required with ease and without disturbing any foodstuffs in the oven chamber 10. Some accessories may be secured in the cavity with releasable fixings, such as bolts, to ensure optimal placement in the cavity, but it should generally be understood that the cavity 30 permits a modular approach to be achieved, with accessories being far more easily and quickly swappable so as to change the cooking or curing process by a user with the oven in situ. It should be understood that the oven 10 may be provided as part of an oven system kit comprising two or more different accessories for providing different oven functionalities with the same oven chamber and housing, and without disturbing the oven chamber or door. For example, a heat source accessory, such as a burner, may be provided in order to initially heat the oven chamber to a high temperature and then the burner could be removed and swapped for a smoker accessory to add smoke to the oven chamber once the oven is up to temperature without opening the oven chamber, which would result in significant heat loss.

As accessories are slidably received and removed in the cavity 30 in a lateral or radial direction, it is not required to move the oven chamber and base in order to change an accessory, or to locate the oven far higher than the support surface to provide sufficient space below the oven. Furthermore, as the accessories are still located below the oven chamber, the energy they supply can be conveniently transferred into the chamber 10 with a short, uncomplicated path (via the conduit 53) which may minimize any energy losses.

The base 20 may comprise a separate component from a remainder of the oven 1. For example, the base 20 may comprise a lower half of the oven and may be attached to an upper half of the oven comprising the oven chamber 10. The base 20 may be attached to the oven chamber 10, for example the base 20 may be attached to the oven floor 13. In other examples, the base may be formed integrally with a remainder of the oven 1. For example, the base 20 may be integrally formed with the oven chamber.

In some examples, the floor 20b of the base, or underside surface 20b of the base 20 may comprise the cavity 30. In these examples the accessory may be inserted upwards and into the base 20 of the oven 1 rather than laterally into the side of the base as shown in FIGS. 1 and 2. In these examples the oven may comprise a lock to prevent the accessory from falling out of the cavity.

It will be appreciated that the accessory can comprise a smoke source (e.g. for hot or cold smoking a foodstuff), e.g. wood chips or similar, and/or a heat source for cooking (e.g. roasting or steaming a foodstuff), e.g. boiling water for steaming or burning or smoldering coals or wood etc. for roasting. The aperture 50 is therefore configured to permit the passage of smoke, heat and/or steam to cook or cure a foodstuff in the oven chamber. The accessory may be receivable (e.g. slidably receivable) in the cavity and removable (e.g. slidably removable) from the cavity.

Therefore, in use, a user may insert an accessory comprising a heat source for cooking (or a smoke source for smoking etc.) a food stuff in the cavity 30 of the oven 1. Before, or after, insertion of the accessory a user may place a foodstuff to be cooked (or smoked) in the oven chamber 10. For example the user may place an uncooked pizza in the oven camber 10 for cooking (or a joint of meat in the oven chamber for smoking). Heat from the heat source (or smoke from the smoke source) will then migrate out of the cavity 30, through the aperture 50 (e.g. through the first aperture 51, conduit 53 and second aperture 52) and enter the oven chamber 10. The oven 1 comprises a chimney 18 fluidly connected to the oven chamber 10 to vent any fluid (e.g. smoke) generated during any part of the cooking or curing process. If the accessory runs out of its energy source, e.g. fuel, then the user may remove the accessory from the cavity 30 and place a new accessory in the cavity 30 to continue the cooking or curing process.

According to one aspect of this disclosure there is provided the oven 1 comprising a plurality of cavities 30, each cavity to receive an accessory (e.g. slidably receive). In this way, different types of energy, or multiple sources of the same type of energy, may be supplied to the oven chamber 10 at the same time. Each cavity 30 shall be capable of receiving any of the different accessories to provide further modularity for a wide range of different cooking or curing methods.

It should be understood that an oven system kit described herein is provided as a kit of parts comprising the oven 1 and a plurality of accessories, each accessory as above being an energy source to cook or cure a foodstuff. Each of the accessories is slidably receivable in and removable from the cavity 30 of the oven 1. Each of the accessories may provide a different type of energy. In this way, different types of energy, or multiple sources of the same type of energy, may be supplied to the oven chamber 10.

The oven cavity 30 should be understood a modular accessory port for the oven. Multiple different accessories, and in particular, energy source accessories (including but not limited to, a cold smoker, hot smoker, or heat source as described above) may each therefore be received in the cavity to supply energy to the oven chamber. In this way, access to the oven is not limited or restricted, since the accessory port is provided in the base, and the oven chamber space can be fully utilized. Furthermore, as access to the cavity is below the oven chamber, space is not only maximized but the accessory port may be accessed in a safe way that does not disturb a cooking or curing process, or the oven chamber itself. Therefore, a cooking or curing process in the oven chamber is effectively separated from introducing, or altering, an accessory providing heat or smoke to the oven chamber. Providing the cavity in the base also means that more control over the airflow may be maintained. It may also mean that the oven may maintain optimum dimensions even when an accessory is used as the accessory may be received in the base. In other words, the oven may be kept as compact as possible.

Other possible accessories may comprise a burner with adjustable airflow, an electric heating element, a gas burner, hot air blower, steam generator.

In the illustrated example, the cavity for receiving an accessory is accessible in a sideways direction (i.e. in the side of the oven when in use) but it should be understood that in other examples, the aperture could be provided on a front or rear of the oven when in use, or anywhere around the oven that is accessible in a substantially lateral direction in use.

It should be understood that, although the heat sources in these specific examples may utilize gas and/or non-gas fuel energy sources, ovens utilizing electrical energy sources, such as radiant elements or fan heaters are equally possible within the principles of this disclosure.

It will be appreciated by a skilled person that although the invention has been described by way of example, with reference to exemplary examples, it is not limited to the disclosed examples and that alternative examples could be constructed without departing from the scope of the invention as defined by the appended claims.

1. An oven system kit comprising:
an oven comprising:
oven chamber for containing foodstuffs during cooking or curing; and
a base for supporting the oven chamber,
wherein the base comprises a cavity for receiving an accessory for supplying energy to cook or cure foodstuffs; and
an aperture for permitting energy from the accessory to flow into the oven chamber; and
a first accessory for supplying energy of a first type to cook or cure foodstuffs,
a second accessory for supplying energy of a second type different to the first type to cook or cure foodstuffs,
wherein the first and second accessories are each configured to be slidably receivable in and removable from the cavity of the oven so as to provide different types of energy to the oven chamber.

2. An oven system kit as claimed in claim 1, wherein the cavity comprises the aperture.

3. An oven system kit as claimed in claim 1, wherein the cavity is located underneath at least part of the oven chamber and/or underneath at least a part of an oven floor of the oven.

4. An oven system kit as claimed in claim 1, wherein the cavity comprises an opening in the side of the base.

5. An oven system kit as claimed in claim 1, wherein the base comprises a sidewall and wherein the sidewall comprises an opening to permit access to the cavity.

6. An oven system kit as claimed in claim 1, wherein the cavity is configured to slidably receive the accessory through the opening.

7. An oven system kit as claimed in claim 1, wherein the oven chamber is at least partially surrounded by an oven housing.

8. An oven system kit as claimed in claim 1, wherein the accessory comprises at least one of a smoke source for cold or hot smoking the foodstuffs, a heat source to cook foodstuffs, and wherein the aperture is configured to permit the passage of smoke from the smoke source, when the smoke source is received in the cavity, into the oven chamber.

9. An oven system kit as claimed in claim 1, wherein the accessory comprises a heat source, and wherein the aperture is configured to permit the passage of heat from the heat source, when the heat source is received in the cavity, into the oven chamber.

10. An oven system kit as claimed in claim 1, further comprising a blanking cap for selectively covering the aperture.

11. An oven system kit as claimed in claim 1, further comprising an oven floor, the oven floor forming a surface of the oven chamber for supporting foodstuffs during cooking.

12. An oven system kit as claimed in claim 11, wherein the cavity is located below the oven floor.

13. An oven system kit as claimed in claim 11, wherein the oven floor comprises the aperture.

14. An oven system kit as claimed in claim 11, wherein the aperture is a first aperture and wherein the cavity comprises the aperture, wherein the oven floor comprises a second aperture, and wherein the first and second apertures form two ends of a conduit, the conduit fluidly connecting the cavity with the oven chamber and forming a passage energy to be supplied from the accessory to the oven chamber.

15. An oven system kit as claimed in claim 1 wherein the cavity comprises a slidable drawer.

16. An oven system kit as claimed in claim 1, wherein the oven is configured to permit energy from the accessory to flow into the oven chamber substantially vertically from the base through the aperture.

17. An oven system kit as claimed in claim 1, further comprising the accessory for supplying energy to cook or cure foodstuffs, wherein the accessory is slidably receivable in and removable from the cavity of the oven.

18. An oven system kit as claimed in claim 17 wherein the accessory is slidably received in the base in a lateral direction.
